(19) United States
(12) Patent Application Publication
(10) Pub. No.: US 2023/0053099 A1
(43) Pub. Date: Feb. 16, 2023

(54) SYSTEM AND METHOD FOR STORAGE OF GASEOUS HYDROGEN

(71) Applicant: PRELOAD CRYOGENICS, LLC, Quincy, MA (US)

(72) Inventors: Sanjay Mehta, Hauppauge, NY (US); Eric T. Reaman, Hingham, MA (US)

(21) Appl. No.: 17/885,904

(22) Filed: Aug. 11, 2022

Related U.S. Application Data
(60) Provisional application No. 63/257,602, filed on Oct. 20, 2021.
(60) Provisional application No. 63/231,782, filed on Aug. 11, 2021.

(51) Int. Cl. F17C 1/06

(52) U.S. Cl. CPC F17C 1/06; F17C 2201/0109; F17C 2203/012; F17C 2203/0604; F17C 2203/0624; F17C 2203/0639; F17C 2203/0678; F17C 2205/018; F17C 2221/012; F17C 2260/036

(57) ABSTRACT

A gaseous hydrogen storage system may include a primary container including a metal sidewall and a metal dome. The primary container may be configured to retain gaseous hydrogen. A portion of the primary container, such as the metal sidewall may be covered with a composite material layer. The metal sidewall and the metal dome may be constructed from carbon steel, stainless steel, a nickel-based steel, and combinations thereof.

### CROSS-REFERENCE TO RELATED APPLICATIONS

This application claims the benefit of U.S. Provisional Application No. 63/231,782 filed on Aug. 11, 2021, and U.S. Provisional Application No. 63/257,602, filed on Oct. 20, 2021. The entire disclosures of the above applications are incorporated herein by reference.

### FIELD

The disclosure generally relates to storage systems and, more particularly, to gaseous hydrogen storage systems.

### INTRODUCTION

This section provides background information related to the present disclosure which is not necessarily prior art.

Hydrogen is a key component of the clean energy transition given the wide-ranging options for its use. Multiple industries are developing uses for hydrogen as a fuel that when produced sustainably (from renewables or through traditional methods plus carbon capture) creates carbon-free emissions at the end user. Hydrogen studies, pilots, and business cases are being developed in heavy duty transportation, power generation, industrial uses such as steel production and ammonia synthesis, and also green heating fuel. One key area of study that has not yet gained attention is storage. Hydrogen may be stored in liquid and gaseous form.

The simplest method for storage of gaseous hydrogen is underground salt caverns. However, this method has geographical limitations and often requires a production resource to be sited near a geologic formation as well as a readily accessible local market. Storage of hydrogen in gaseous form may be challenging because it is the lightest of the elements and has an atomic radius of 1.00794 a.m.u. Hydrogen may also penetrate the lattice structure of metals and cause hydrogen embrittlement, which may be responsible for fracture of alloy steels under high tensile stress conditions. Although it is possible to combine hydrogen with other elements, such as nitrogen to form ammonia, a lot of energy may be consumed in this process. Additional energy may also be required to extract hydrogen from ammonia, thus making the process uneconomical and inefficient. The problem of storing large quantities of hydrogen in gaseous form needs to be addressed to make the hydrogen economy feasible for commercial use.

Accordingly, there is a need for a commercial hydrogen storage system. Desirably, the gaseous hydrogen storage system may efficiently retain gaseous hydrogen and may be economically constructed.

### SUMMARY

In concordance with the instant disclosure, a gaseous hydrogen storage system and method that is configured to be more economically constructed while also efficiently retaining gaseous hydrogen by reducing the permeability of the storage system, has been surprisingly discovered.

In certain embodiments, a gaseous hydrogen storage system is provided that includes a primary container. The primary container may include a metal sidewall and a metal dome, where the primary container may be configured to retain gaseous hydrogen. The metal sidewall may be covered with a composite material layer.

In certain embodiments, a gaseous hydrogen storage system may include a primary container including a metal sidewall and a metal dome. The primary container may be configured to retain gaseous hydrogen. The metal sidewall may be covered with a composite material layer. The metal sidewall and the metal dome may be constructed from carbon steel, stainless steel, a nickel-based steel, and combinations thereof.

The gaseous hydrogen storage system can further include the following various aspects. The composite material layer may be disposed outside of a concrete wall. The composite material layer may further be disposed outside of the metal sidewall and the metal sidewall may be sandwiched between the composite material layer and the concrete wall. The concrete wall may be disposed outside of the metal sidewall. The composite material layer may further be disposed outside of the concrete wall and the concrete wall may be sandwiched between the metal sidewall and the composite material layer.

The primary container of the gaseous hydrogen storage system may be prestressed by compression with prestressed wire. The prestressed wire may be encapsulated within the composite material layer. In certain embodiments, the composite material layer may be in compression with the prestressed wire. The prestressed wire may be disposed in one of a vertical orientation, a horizontal orientation, and combinations thereof.

The gaseous hydrogen storage system may further include a concrete footing for supporting the gaseous hydrogen storage system. The metal sidewall may include a steel liner forming a substantially cylindrical structure. The metal dome may include a spherical head fabricated from one or more steel plates. In certain embodiments, the metal sidewall may be 3/16″ thick. In particular, a thickness of the metal sidewall may be proportional to an internal pressure and a diameter of the primary container.

In certain embodiments, various ways of assembling the gaseous hydrogen storage system are provided. Such methods may include providing a primary container and a composite material. The primary container may be disposed in a predetermined position. Then, a portion of the primary container, such as the metal sidewall may be covered with the composite material.

In certain embodiments, a method of assembling a gaseous hydrogen storage system may include providing a primary container including a metal sidewall and a metal dome, providing a composite material layer, disposing the primary container in a predetermined position, and covering a portion of the primary container, such as the metal sidewall with the composite material, thereby forming a composite material layer.

Assembling the gaseous hydrogen storage system can further include the following various aspects. Assembly may include disposing the composite material outside of a concrete wall. The composite material layer may be further disposed outside of the metal sidewall, and the metal sidewall may be sandwiched between the composite material layer and the concrete wall. A concrete wall may be disposed outside of the metal sidewall. The composite material layer may be further disposed outside of the concrete wall, and the concrete wall may be sandwiched between the metal sidewall and the composite material layer.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a schematic view of a first embodiment of a gaseous hydrogen storage system, in accordance with the present technology;

FIG. 2 shows an enlarged schematic view of an upper portion of the first embodiment of the gaseous hydrogen storage system;

FIG. 3 shows an enlarged schematic view of a lower portion of the first embodiment of the gaseous hydrogen storage system;

FIG. 4 shows a schematic view of a second embodiment of a gaseous hydrogen storage system having an inner metal liner, in accordance with the present technology;

FIG. 5 shows an enlarged schematic view of an upper portion of the second embodiment of the gaseous hydrogen storage system having the inner metal liner;

FIG. 6 shows an enlarged schematic view of a mid portion of the second embodiment of the gaseous hydrogen storage system having the inner metal liner;

FIG. 7 shows an enlarged schematic view of a lower portion of the second embodiment of the gaseous hydrogen storage system having the inner metal liner; and

FIG. 8 shows a flowchart of a method of assembling a gaseous hydrogen storage system, in accordance with the present technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9,1-8,1-3,1-2,2-10,2-8,2-3,3-10,3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIGS. is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to a gaseous hydrogen storage system configured to retain gaseous hydrogen. The gaseous hydrogen storage system may include a primary container including a metal sidewall and a metal dome. The primary container may be configured to retain gaseous hydrogen. A portion of primary container may be covered with a composite material layer. For example, the metal sidewall may be covered with the composite material layer. The metal sidewall and the metal dome may be constructed from carbon steel, stainless steel, a nickel-based steel, and combinations thereof.

The composite material layer may be disposed outside of a concrete wall. In certain embodiments, the composite material layer may be further disposed outside of the metal sidewall, and the metal sidewall may be sandwiched between the composite material layer and the concrete wall. The concrete wall may be disposed outside of the metal sidewall. In certain embodiments, the composite material layer may be further disposed outside of the concrete wall, and the concrete wall may be sandwiched between the metal sidewall and the composite material layer.

The primary container may be prestressed by compression with prestressed wire. The prestressed wire may be encapsulated within the composite material layer. In certain embodiments, the composite material layer may be in compression with the prestressed wire. The prestressed wire may be disposed in one of a vertical orientation, a horizontal orientation and combinations thereof.

The gaseous hydrogen storage system may further include a concrete footing for supporting the gaseous hydrogen storage system. The metal sidewall may include a steel liner forming a substantially cylindrical structure. The metal dome may include a spherical head fabricated from one or more steel plates. In certain embodiments, the metal sidewall may be 3/16″ thick. In particular, a thickness of the metal sidewall may be proportional to an internal pressure and a diameter of the primary container.

A method of assembling a hydrogen storage system may include providing a primary container including a metal sidewall and a metal dome, providing a composite material layer, disposing the primary container in a predetermined position, and covering a portion of the primary container, such as the metal sidewall with the composite material, thereby forming a composite material layer.

In certain embodiments, the method may include disposing the composite material layer outside of a concrete wall. The composite material layer may be further disposed outside of the metal sidewall, and the metal sidewall may be sandwiched between the composite material layer and the concrete wall. In certain embodiments, a concrete wall may be disposed outside of the metal sidewall. The composite material layer may be further disposed outside of the concrete wall, such that the concrete wall may be sandwiched between the metal sidewall and the composite material layer.

Advantageously, the gaseous hydrogen storage system provides an economically constructed container which efficiently retains hydrogen by reducing the permeability of the storage system and at the same time, providing protection against external hazards such as fire, missile impact explosions, and other external hazards.

### EXAMPLES

Example embodiments of the present technology are provided with reference to the several figures enclosed herewith.

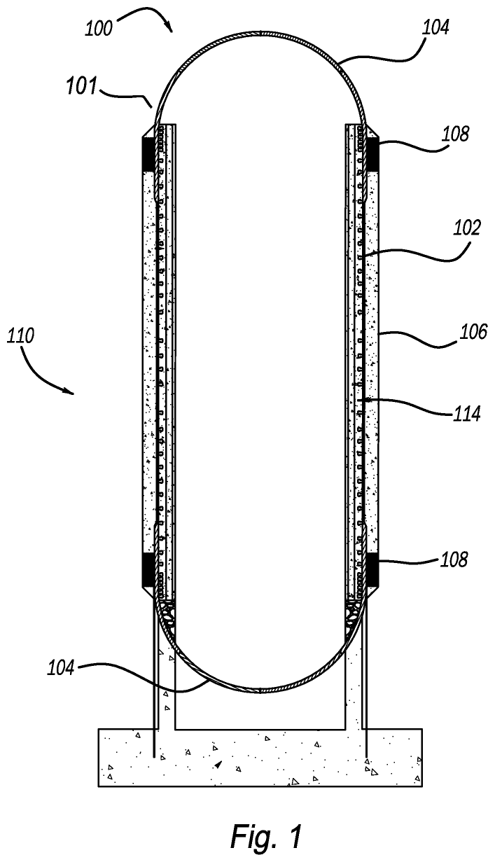

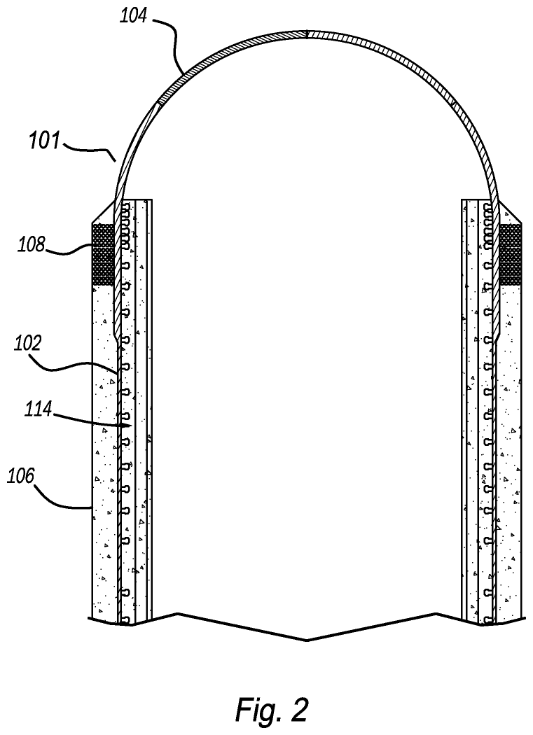

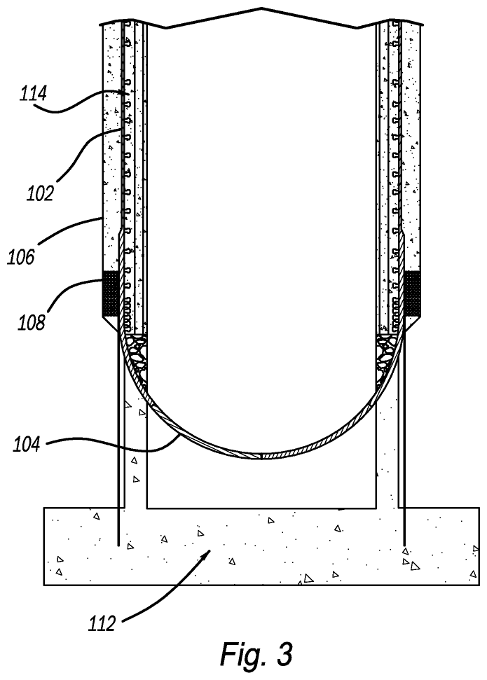

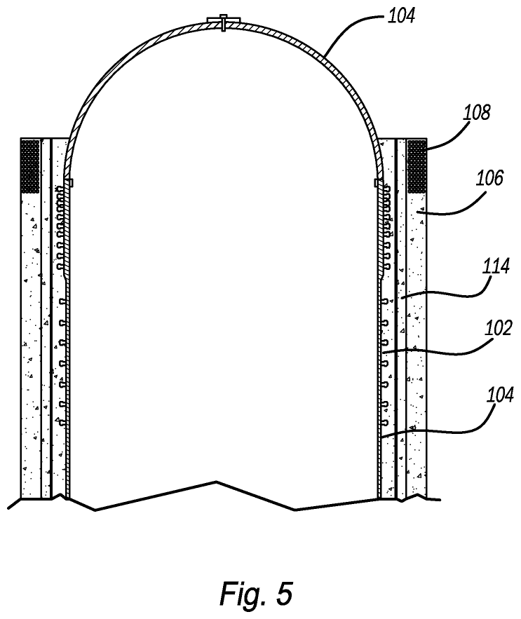

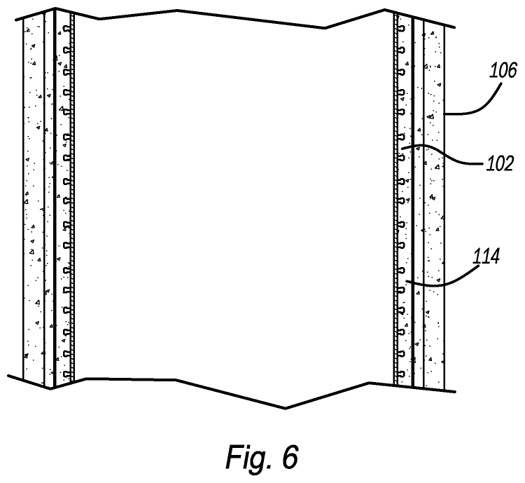

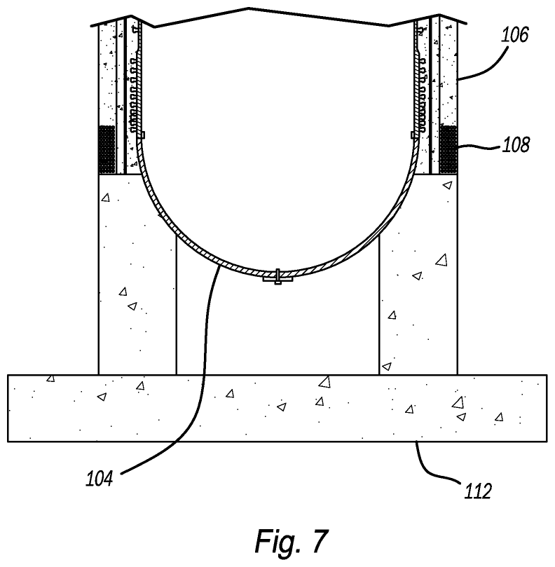

As shown in FIGS. 1-7, a gaseous hydrogen storage system 100 is provided that includes a primary container 101. The primary container 101 may include a metal sidewall 102 made composite with prestressed concrete and a metal dome 104 that are configured to retain gaseous hydrogen. In certain embodiments, the prestressed concrete may include a composite material layer 106 added to a portion of the primary container 101. The composite material layer 106 may comprise a dry mix or a wet mix of sprayed concrete or mortar. In certain embodiments, the composite material layer 106 may include shotcrete material. The composite material layer 106 may be applied by spraying or otherwise being projected onto a portion of the primary container 101. However, the composite material layer 106 may be added to a portion of the primary container 101 using any method as appropriately desired.

With continued reference to FIGS. 1-7, the primary container 101 may have certain functionalities that may be performed by various types of materials. For example, the primary container 101 may be constructed from a material configured to mitigate against damage due to hydrogen embrittlement. As a non-limiting example, the metal sidewall 102 and the metal dome 104 of the primary container 101 may include a carbon steel material or a stainless steel material or any other material that may sustain damage due to hydrogen embrittlement. In certain embodiments, the metal sidewall 102 and/or the metal dome 104 may include nickel. In a specific example, the metal sidewall 102 and/or the metal dome 104 may include stainless steel material.

In certain embodiments, the primary container 101 may be prestressed. Prestressing may include where the primary container 101 is compressed by prestressed wires 108. The prestressed wires 108 may be encapsulated in the composite material layer 106 to provide protection against corrosion. In a specific example, the composite material layer 106 may include disposing the prestressed wires 108 in a predetermined orientation and encapsulating the plurality of prestressed wires 108 with shotcrete material. Precast portions of the composite material layer 106 may be prestressed during the assembly process (pre-tensioning) or portions of the composite material layer 106 may be stressed once completed (post-tensioning). Prestressing of the prestressed wires 108 may compensate for a tensile stress of the stored hydrogen. Thus, the composite material layer 106 may generally remain in compression in conjunction with the prestressed wires 108. In a specific example, the orientation of the prestressed wires 108 may be a vertical orientation, a horizontal orientation, and a combination thereof.

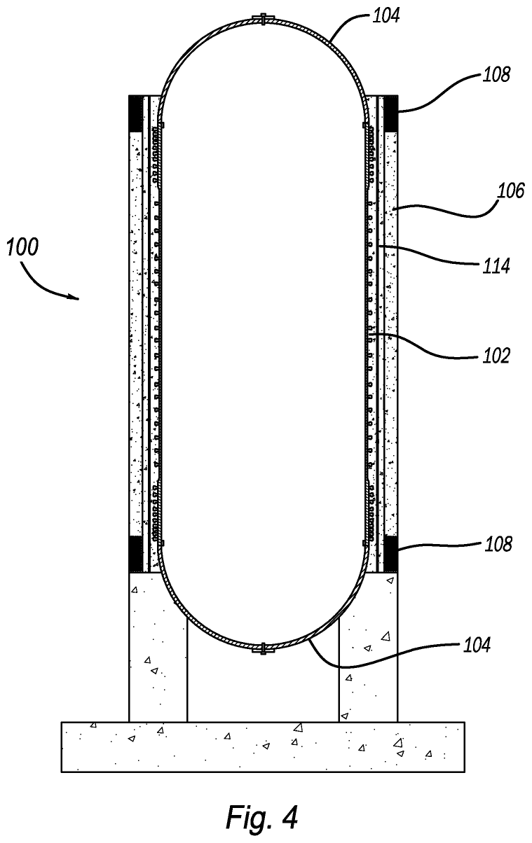

In certain embodiments, as shown in FIGS. 1 and 4, the gaseous hydrogen storage system 100 may be provided in a standing or vertical configuration 110. The standing configuration 110 may require the gaseous hydrogen storage system 100 to further include a concrete footing 112 that may be used to support the gaseous hydrogen storage system 100. The gaseous hydrogen storage system 100 may be provided in a horizontal position (not shown) in some embodiments.

In certain embodiments, as shown in FIGS. 1-7, the gaseous hydrogen storage system 100 may include ways to specifically retain gaseous hydrogen in large volumetric capacities. For instance, the metal sidewall 102 may be a thin steel liner forming a substantially cylindrical structure. The primary container 101 may include a prestressed concrete cylindrical shell surrounding the metal sidewall 102. The metal dome 104 may include a spherical head fabricated from thick steel plates disposed on a terminal end of the metal sidewall 102. In a specific example, a metal dome 104 may be disposed on each end of the metal sidewall 102. The purpose of the steel liner is to provide gas tightness because concrete is permeable to gases, especially hydrogen. Advantageously, the thickness of the metal sidewall 102 may be reduced as the prestressed concrete cylindrical shell of the composite material layer 106 is able to resist the stresses from an internal pressure of the retained hydrogen. Desirably, the thinner steel liner of the metal sidewall 102 may be more practical to weld. In a specific example, the thickness of the steel liner of the metal sidewall 102 is typically around 3/16″ when acting in conjunction with the prestressed concrete cylindrical shell. In certain embodiments, the metal sidewall 102 includes a cylindrical metal sidewall.

As shown in FIGS. 1-7, in certain embodiments, the volumetric capacity of the gaseous hydrogen storage system 100 may be about 133,905 ft³ or about one million gallons. This approximately equals to about 7,975 kg (21,000 lbs) of hydrogen gas at 350 psi. The gaseous hydrogen storage system 100 may be scalable by increasing the height of the metal sidewall 102 along with the height of prestressed concrete portion acting compositely with the metal wall. For example, doubling the height of the metal sidewall 102 and composite material layer 106 may increase an amount of stored hydrogen gas to about 11,963 kg (26,319 lbs). Since a thickness of the metal sidewall 102 is proportional to the internal pressure and the diameter, increasing the metal sidewall 102 height and composite material layer 106 height will not increase the required thickness of the metal sidewall 102. Likewise, the overall thickness of the metal dome 104 or hemispherical head(s) will not increase where the volumetric capacity of the gaseous hydrogen storage system 100 is enlarged by increasing the height of the metal sidewall 102.

The gaseous hydrogen storage system 100 may be provided in various configurations. For instance, as shown in FIGS. 1-3, the metal sidewall 102 may be disposed outside of a concrete wall 114. The composite material layer 106 may then be disposed outside of the metal sidewall 102, thereby sandwiching the metal sidewall 102 between the composite material layer 106 and the concrete wall 114. In an alternative configuration, as shown in FIGS. 4-7, the metal sidewall 102 may be the innermost layer of the gaseous hydrogen storage system 100. The concrete wall 114 may be disposed outside of the metal sidewall 102. The composite material layer 106 may then be disposed outside of the concrete wall 114, thereby sandwiching the concrete wall 114 between the metal sidewall 102 and the composite material layer 106.

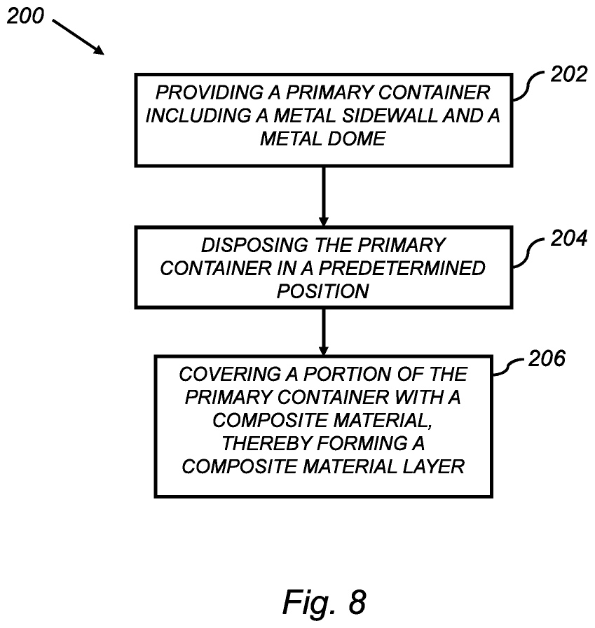

FIG. 8 shows a method 200 of assembling the gaseous hydrogen storage system. As shown in FIG. 8, the method 200 may include a step 202 of providing a primary container 101 including a metal sidewall 102 and a metal dome 104, and a composite material. The primary container 101 may be disposed in a predetermined position in another step 204. In a further step 206, a portion of the primary container 102 may be covered with a composite material to form the composite material layer 106. For example, the metal sidewall 102 may be covered with the composite material to form the composite material layer 106. In certain embodiments, the metal sidewall 102 may be disposed outside of a concrete wall 114 of the gaseous hydrogen storage system 100. The composite material layer 106 may then be disposed outside of the metal sidewall 102, such that the metal sidewall 102 is sandwiched between the composite material layer 106 and the concrete wall 114. Alternatively, the concrete wall 114 may be disposed outside of the metal sidewall 102. The composite material layer 106 may then be disposed outside of the concrete wall 114, such that the concrete wall 114 is sandwiched between the metal sidewall 102 and the composite material layer 106.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A gaseous hydrogen storage system configured to retain gaseous hydrogen, comprising:
a primary container including a metal sidewall and a metal dome, the primary container configured to retain gaseous hydrogen, wherein the metal sidewall is covered with a composite material layer.

2. The gaseous hydrogen storage system of claim 1, wherein the metal sidewall and the metal dome are constructed from carbon steel, stainless steel, a nickel-based steel, and combinations thereof.

3. The gaseous hydrogen storage system of claim 1, further comprising a concrete wall, wherein the composite material layer is disposed outside of the concrete wall.

4. The gaseous hydrogen storage system of claim 3, wherein the composite material layer is disposed outside of the metal sidewall, the metal sidewall sandwiched between the composite material layer and the concrete wall.

5. The gaseous hydrogen storage system of claim 1, further comprising a concrete wall, wherein the concrete wall is disposed outside of the metal sidewall.

6. The gaseous hydrogen storage system of claim 5, wherein the composite material layer is disposed outside of the concrete wall, the concrete wall sandwiched between the metal sidewall and the composite material layer.

7. The gaseous hydrogen storage system of claim 1, wherein the primary container is prestressed by compression with prestressed wire.

8. The gaseous hydrogen storage system of claim 7, wherein the prestressed wire is encapsulated within the composite material layer.

9. The gaseous hydrogen storage system of claim 8, wherein the composite material layer is in compression with the prestressed wire.

10. The gaseous hydrogen storage system of claim 7, wherein the prestressed wire is disposed in one of a vertical orientation, a horizontal orientation, and combinations thereof.

11. The gaseous hydrogen storage system of claim 1, further comprising a concrete footing for supporting the primary container.

12. The gaseous hydrogen storage system of claim 1, wherein the metal sidewall includes a steel liner forming a substantially cylindrical structure.

13. The gaseous hydrogen storage system of claim 1, wherein the metal dome includes a hemispherical head fabricated from one or more steel plates.

14. The gaseous hydrogen storage system of claim 1, wherein the metal sidewall is 3/16″ thick.

15. The gaseous hydrogen storage system of claim 1, wherein the composite material layer comprises shotcrete.

16. A method of assembling a hydrogen storage system, comprising:
providing a primary container including a metal sidewall and a metal dome;
disposing the primary container in a predetermined position; and
covering the metal sidewall with a composite material, thereby forming a composite material layer.

17. The method of claim 16, further comprising disposing the metal sidewall outside of a concrete wall.

18. The method of claim 17, further comprising disposing the composite material layer outside of the metal sidewall, wherein the metal sidewall is sandwiched between the composite material layer and the concrete wall.

19. The method of claim 16, further comprising disposing a concrete wall outside of the metal sidewall.

20. The method of claim 19, further comprising disposing the composite material layer outside of the concrete wall, wherein the concrete wall is sandwiched between the metal sidewall and the composite material layer.
